(19) United States
(12) Patent Application Publication
(10) Pub. No.: US 2002/0092499 A1
(43) Pub. Date: Jul. 18, 2002

(54) Detonation sensing of crankshaft position

(76) Inventors: John S. Kargilis, Northville, MI (US); David J. Kujawa, White Lake, MI (US); Martin Berger, Livonia, MI (US)

Correspondence Address: Mark P Calcaterra, DaimlerChrysler Intellectual Capital Corporation, CIMS 483 -02 -19, 800 Chrysler Drive East, Auburn Hills, MI, 48326-2757, US

(21) Appl. No.: 09/759,495

(22) Filed: Jan. 12, 2001

(51) Int. Cl. F02M 51/00; F02P 5/00; G01M 15/00

(52) U.S. Cl. 123/406.58; 123/494; 73/116

(57) ABSTRACT

A method for determining the position of a crankshaft without the use of a signal from a dedicated crankshaft position sensor. The method includes the steps of providing a pulse sensor for generating a signal in response to the transmission of vibrations through the engine block; evaluating the signal generated by the pulse sensor to identify a series of combustion events, the series of combustion events being made up of a series of individual combustion events occurring in the plurality of cylinders, the individual combustion events taking place in a predetermined order; and evaluating the series of combustion events to identify a reference crankshaft position by correlating at least one of the individual combustion events to an associated one of the plurality of cylinders.

### BACKGROUND OF THE INVENTION

1. Technical Field

The present invention relates generally to an internal combustion engines and more particularly to a method of replicating a crankshaft position signal for an internal combustion engine.

2. Discussion

Modern internal combustion engines include a crankshaft that is mechanically linked to a camshaft. The relative positions of the crankshaft and camshaft are obtained through sensing mechanisms, such as a dedicated crankshaft position sensor and a camshaft position sensor, respectively. The signal from these sensors is transmitted to a mechanism, such as an engine controller, for controlling engine functions, such as spark and fuel timing. For example, the engine controller utilizes the signal from the crankshaft position sensor to control operations dependant upon crankshaft position, such as the timing of the spark and the dispensing of fuel through the fuel injectors. Similarly, the engine controller utilizes the signal from the dedicated camshaft position sensor to establish the rotational position of the crankshaft relative to the camshaft (i.e., synchronize the crankshaft to the camshaft). As most modern engines are of the four-cycle design, the crankshaft rotates two complete revolutions to every one revolution of the camshaft. Synchronization of the crankshaft to the camshaft prevents the engine controller from dispensing fuel and firing a spark when the camshaft is 180 degrees out of position.

If for any reason the signal from the dedicated crankshaft position sensor were unavailable, the engine controller would not be able to control the engine operations that are dependant upon the crankshaft position, thus preventing the engine from operating. Thus, there is a need in the art for a method of determining the absolute position of a crankshaft in the absence of a crankshaft position signal from a dedicated crankshaft position sensor.

### SUMMARY OF THE INVENTION

It is one object of the present invention to provide a method for determining the position of a crankshaft without the use of a signal from a dedicated crankshaft position sensor. The method includes the steps of providing a pulse sensor for generating a signal in response to the transmission of vibrations through the engine block; evaluating the signal generated by the pulse sensor to identify a series of combustion events, the series of combustion events being made up of a series of individual combustion events occurring in the plurality of cylinders, the individual combustion events taking place in a predetermined order; and evaluating the series of combustion events to identify a reference crankshaft position by correlating at least one of the individual combustion events to an associated one of the plurality of cylinders.

### BRIEF DESCRIPTION OF THE DRAWINGS

Additional advantages and features of the present invention will become apparent from the subsequent description and the appended claims, taken in conjunction with the accompanying drawings wherein:

FIG. 1 is a schematic diagram of an engine control system constructed and operated in accordance with the teachings of the present invention;

FIG. 2A is a schematic diagram of an exemplary crankshaft position signal;

FIG. 2B is a schematic diagram of an exemplary camshaft position signal;

FIG. 2C is a schematic diagram of an exemplary pulse signal illustrating a series of combustion events;

FIG. 3 is a schematic diagram in flowchart form of the method for determining the position of a crankshaft according to a preferred embodiment of the present invention; and

FIG. 4 is a schematic diagram in flowchart form of the method for determining the position of a crankshaft according to an alternate embodiment of the present invention.

### DETAILED DESCRIPTION OF THE PREFERRED EMBODIMENT

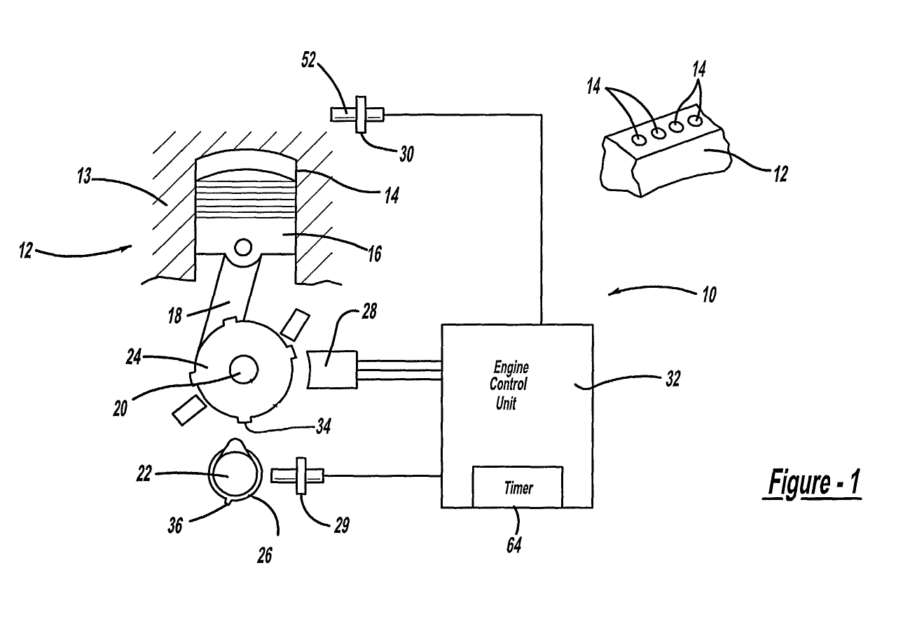

Referring to FIG. 1, an engine control system 10 used in conjunction with a method according to a first embodiment of the present invention is schematically illustrated with a four-cycle internal combustion engine 12. Engine 12 includes an engine block 13 that is partially shown in a cut-away view, illustrating one of a plurality of cylinders 14 in engine 12. In the particular example provided, engine 12 includes four cylinders 14. Engine 12 includes a piston 16 disposed within each cylinder 14 which is operably connected by a connecting rod 18 to a crankshaft 20. A camshaft 22 is used to open and close at least one intake valve (not shown) and at least one exhaust valve (not shown) of cylinder 14 for various strokes of piston 16. In a four-stroke spark-ignited engine, these strokes include intake, compression, power and exhaust. It should be appreciated that crankshaft 20 and camshaft 22 are mechanically linked together.

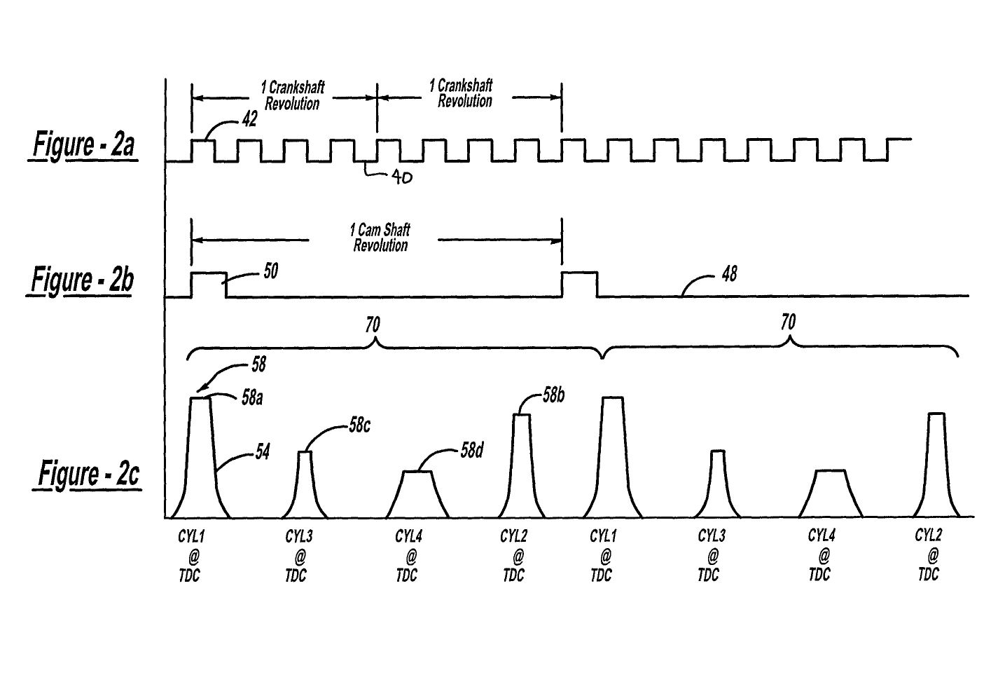

Engine control system 10 includes a crankshaft sensor target 24, a camshaft sensor target 26, a crankshaft position sensor 28, a camshaft position sensor 29, a pressure pulse sensor 30 and an engine controller 32. Crankshaft sensor target 24 is coupled for rotation with crankshaft 20 and has at least one, but preferably a plurality of trip points 34 that are employed by crankshaft position sensor 28 to generate a crankshaft position signal. With additional reference to FIG. 2A, crankshaft sensor target 24 includes four trip points 34 and as such, crankshaft position sensor 28 produces a crankshaft position signal 40 having four peaks 42 per revolution of the crankshaft 20 in the particular example provided.

Similarly, camshaft sensor target 26 is coupled for rotation with the camshaft 22 and preferably includes a single trip point 36 that is employed by the camshaft position sensor 29 to generate a camshaft position signal. With additional reference to FIG. 2B, the camshaft position sensor 29 produces a camshaft position signal 48 having one peak 50 per two revolutions of the crankshaft 20 since the camshaft 22 rotates at one-half the velocity of the crankshaft 20.

The pressure pulse sensor 30 is mounted to engine 12 to either directly monitor cylinder pressure or to indirectly monitor the effects of the pressure pulse on another fluid, such as air, oil or coolant. It should be noted, however, that as most modern vehicles already include at least one knock or detonation sensor 52 which generates a signal in response to the transmission of vibrations through the engine block 13, the use of an accelerometer or detonation sensor for detecting pressure pulses is preferred so as to eliminate the need to incorporate additional sensors into engine 12. A detonation sensor 52 is also preferred due to its typical sensitivity and rate of response. With additional reference to FIG. 2C, the pressure pulse sensor 30 produces a pressure pulse signal 54 having four peaks 58 per two revolutions of the crankshaft 20, with each peak corresponding to a combustion event in one of the plurality of engine cylinders 14.

The engine controller 32 includes a time keeping mechanism or timer 64 and is coupled to the crankshaft position sensor 28, the camshaft position sensor 29 and the pulse sensor 30 and receives their output. Those skilled in the art will understand that the engine 12 also includes various other sensors (e.g., a throttle position sensor and a manifold absolute pressure sensor) and hardware to permit the engine 12 to carry out its operation which are not shown but conventional and well known in the art. The outputs of these sensors also communicate with engine controller 32.

It should be appreciated that engine controller 32 utilizes the outputs of sensors 28 and 29 to determine the radial position of the crankshaft 20 and thereby determine the position of piston 16 within cylinder 14. It should further be appreciated that the output from crankshaft position sensor 28 is used to determine a speed of engine 12, typically measured in revolutions per minute (RPM), as well as to control a plurality of crankshaft position dependent operations. One crankshaft position dependent operation is the spark timing or spark advance. The spark timing is the timing of the delivery of a spark to a cylinder 14 and is typically quantified as the number of crankshaft angle degrees before top-dead-center on the compression stroke. The engine controller 32 controls the spark timing to initiate a spark (via a spark plug which is not shown) in an individual cylinder to burn a charge of fuel in that cylinder. Other crankshaft position dependent operations may include, for example, the timing of the delivery of fuel to an individual cylinder and the actuation of a mechanism, such as a decompression valve, to decompress an individual cylinder for engine braking.

It should be appreciated that detonation sensor 52 detects vibration within engine 12 and that the engine controller 32 utilizes the output signal of the detonation sensor 52 to identify peaks 58 in the pressure pulse signal 54. Detonation sensor 52 is operable for measuring low intensity vibrations caused by combustion events in the individual cylinders 14 which are created when crankshaft 20 is rotated and fuel in the individual cylinders 14 is combusted. Preferably, each combustion event produces a peak 58 in the pressure pulse signal 54 that can be correlated to the individual cylinder 14 in which the combustion event occurred. Operation in this manner provides increased accuracy and reduces the time that is necessary to determine the position of the crankshaft 20. With specific reference to FIG. 2C, each of the peaks 58 in the pressure pulse signal 54 is indicative of a combustion event in an associated one of the cylinders 14. In the particular example provided, the detonation sensor 52 is located closest to a cylinder 14 identified as “cylinder 1” and is progressively further from those cylinders 14 identified as “cylinder 2”, “cylinder 3” and “cylinder 4”. Since the magnitude of the vibrations produced by combustion events in each of the cylinders 14 varies with the distance between the detonation sensor 52 and the particular cylinder 14 in which the combustion event occurred, and since the firing order of the engine 12 is known, correlation of a combustion event to a particular cylinder 14 when the engine 12 is operating under relatively steady conditions can be accomplished relatively quickly and accurately.

In this regard, a series of combustion events 70 is first identified, with the series of combustion events 70 including one combustion event in each of the individual cylinders 14. As mentioned above, each combustion event is identified by a peak 58. Once a series of combustion events 70 has been identified, the position of the crankshaft 20 can be determined by correlating one or more of the 20 peaks 58 to a particular cylinder 14. In the example provided, the peak 58a is of the highest magnitude and as such, must correlate to cylinder 1 since cylinder 1 is closest to the detonation sensor 52. Similarly, peaks 58b, 58c and 58d decrease in magnitude and as such, correlate to cylinders 2, 3 and 4, respectively, since these cylinders are increasingly further from the detonation sensor 52. Those skilled in the art will understand that correlation between the peaks 58 and the individual cylinders 14 may alternatively be accomplished through the use of look-up tables that permit peak 58 to be associated directly with an individual cylinder 14 based on its absolute magnitude and the current operating conditions (e.g., manifold absolute pressure and rotational speed).

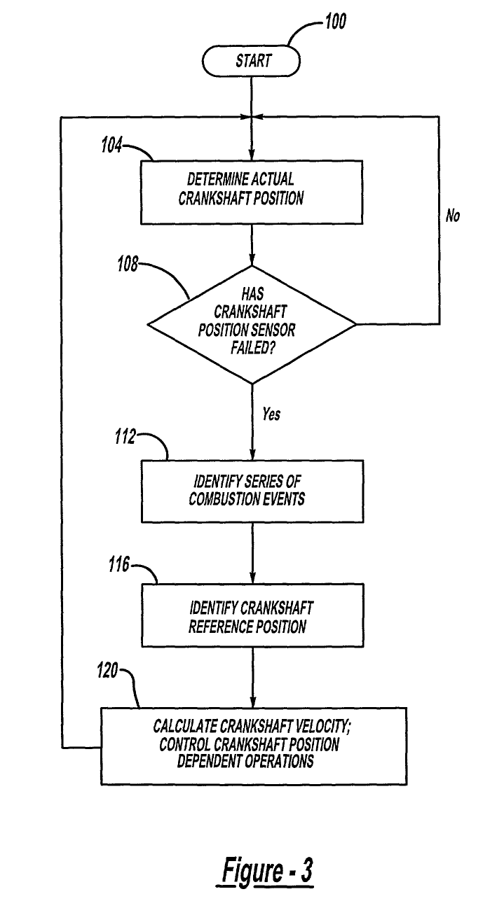

Referring to FIG. 3, a method for determining the position of a crankshaft 20 according to the teachings of the present invention is schematically illustrated in flowchart form. The methodology begins at bubble 100 and progresses to block 104 wherein the methodology utilizes the camshaft position signal 48 and the crankshaft position signal 40 to determine the position of the crankshaft 20. The methodology proceeds to decision block 108 and determines whether the crankshaft sensor 28 has failed.

If the crankshaft sensor 28 has not failed, the methodology loops back to block 104. If the crankshaft sensor 28 has failed in decision block 108, the methodology proceeds to block 112 where the pressure pulse signal 54 is evaluated to identify a series of combustion events 70. Those skilled in the art will understand that filtering of the signal produced by the detonation sensor 52 may be needed to permit each of the peaks 58 to be identified. The methodology next proceeds to block 116 wherein the series of combustion events 70 is employed to identify a crankshaft reference position by correlating at least one of the combustion events to an individual cylinder 14.

The methodology next proceeds to block 120 where the methodology calculates the rotational velocity of the crankshaft 20 and employs the crankshaft reference position and the series of combustion events 70 to control a plurality of crankshaft dependent operations. The method then loops back to decision block 108.

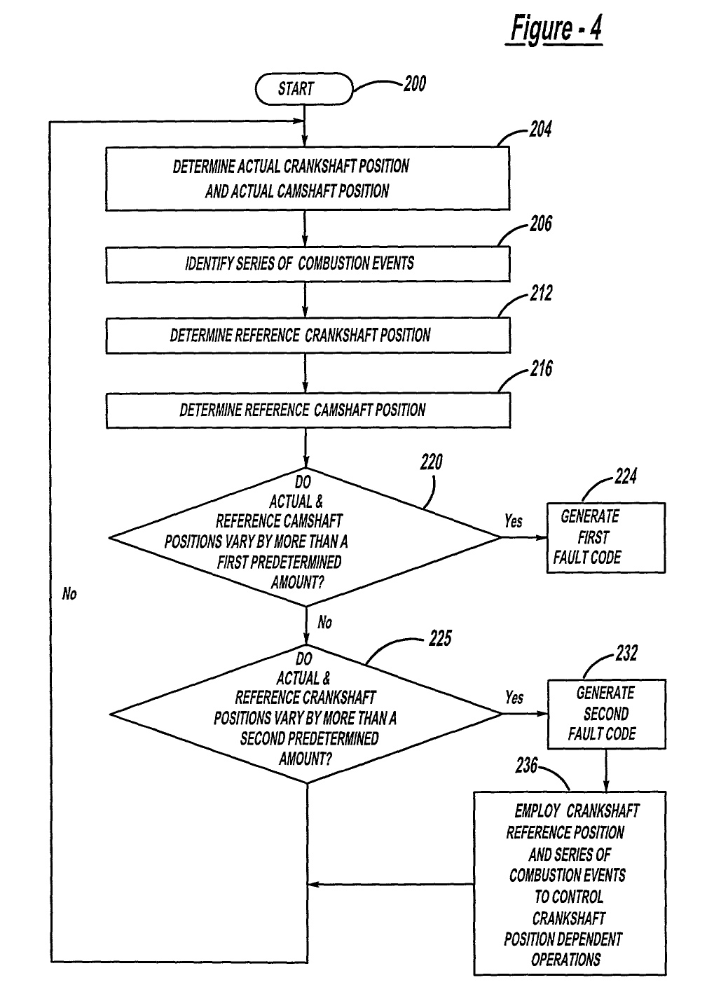

A method according to the teachings of an alternate embodiment of the present invention is illustrated in FIG. 4. The method begins at bubble 200 and progresses to block 204 where the methodology utilizes the camshaft position signal 48 and the crankshaft position signal 40 to determine an actual camshaft position and an actual crankshaft position. The methodology then proceeds to block 208 where the pressure pulse signal 54 is evaluated to identify a series of combustion events 70. The methodology next proceeds to block 212 wherein the series of combustion events 70 and the actual camshaft position are employed to identify a crankshaft reference position. The methodology then proceeds to block 216 where the methodology employs the crankshaft reference position to determine a reference camshaft position. The methodology next process to decision block 220.

In decision block 220, the methodology compares the actual camshaft position to the reference camshaft position and determines if they vary from one another by more than a first predetermined amount. If the actual camshaft position and the reference camshaft position vary by more than the first predetermined amount, the methodology proceeds to block 224 wherein a first fault code is generated. The methodology then proceeds to decision block 228. Returning to decision block 220, if the actual camshaft position and the reference camshaft position do not vary by more than the first predetermined amount, the methodology proceeds to decision block 228.

In decision block 228, the methodology compares the actual crankshaft position to the reference crankshaft position and determines if they vary from one another by more than a second predetermined amount.

If the actual crankshaft position and the reference crankshaft position vary by more than the second predetermined amount, the methodology proceeds to block 232 wherein a second fault code is generated. The methodology then proceeds to block 236 wherein the crankshaft reference position and the series of combustion events are employed to control a plurality of crankshaft dependent operations. The method then loops back to block 204.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. A method for determining a position of a crankshaft in an operating engine, the engine including an engine block and a plurality of cylinders, the method comprising the steps of:
providing a pulse sensor for generating a signal in response to the transmission of vibrations through the engine block;
evaluating the signal generated by the pulse sensor to identify a series of combustion events, the series of combustion events being made up of a series of individual combustion events occurring in the plurality of cylinders, the individual combustion events taking place in a predetermined order; and
evaluating the series of combustion events to identify a reference crankshaft position by correlating at least one of the individual combustion events to an associated one of the plurality of cylinders.

2. The method of claim 1, further comprising the step of employing the series of combustion events and the crankshaft reference position to determine a crankshaft rotational velocity.

3. The method of claim 1, further comprising the step of employing the crankshaft reference position and the series of combustion events to control a plurality of crankshaft position dependent operations.

4. The method of claim 3, wherein the crankshaft position dependent operations includes a spark timing operation.

5. The method of claim 3, wherein the crankshaft position dependent operations includes a fuel delivery operation.

6. The method of claim 1, further including the step of employing the crankshaft reference position to determine a camshaft reference position.

7. The method of claim 1, wherein the pulse sensor is an accelerometer.

8. A method for determining a position of a crankshaft in an operating engine, the engine including an engine block, a camshaft timed to the crankshaft and a plurality of cylinders, the method comprising the steps of:
providing a pulse sensor for generating a signal in response to the transmission of vibrations through the engine block;
providing a camshaft sensor for generating a camshaft position signal indicative of a position of the camshaft;
evaluating the camshaft position signal to determine an actual camshaft position;
evaluating the signal generated by the pulse sensor to identify a series of combustion events, the series of combustion events being made up of a series of individual combustion events occurring in the plurality of cylinders, the individual combustion events taking place in a predetermined order; and
employing the series of combustion events and the actual camshaft position to identify a reference crankshaft position by correlating the position of the camshaft to the position of the crankshaft.

9. The method of claim 8, further comprising the step of employing the series of combustion events and the crankshaft reference position to determine a crankshaft rotational velocity.

10. The method of claim 8, further comprising the step of employing the crankshaft reference position and the series of combustion events to control a plurality of crankshaft position dependent operations.

11. The method of claim 10, wherein the crankshaft position dependent operations includes a spark timing operation.

12. The method of claim 10, wherein the crankshaft position dependent operations includes a fuel delivery operation.

13. The method of claim 8, further including the step of employing the crankshaft reference position to determine a camshaft reference position.

14. The method of claim 13, further including the steps of:
determining whether the camshaft reference position and the actual camshaft position vary by more than a predetermined value; and
employing the camshaft reference position to control a plurality of camshaft position dependent operations if the camshaft reference position and the actual camshaft position vary by more than the predetermined value.

15. The method of claim 14, further comprising the step of generating a fault code if the camshaft reference position and the actual camshaft position vary by more than the predetermined value.

16. The method of claim 8, wherein the pulse sensor is an accelerometer.

17. A method for determining a position of a crankshaft in an operating engine, the engine including an engine block, a camshaft timed to the crankshaft and a plurality of cylinders, the method comprising the steps of:
providing a crankshaft sensor for generating a crankshaft position signal indicative of a position of the crankshaft;
providing a pulse sensor for generating a signal in response to the transmission of vibrations through the engine block;
evaluating the crankshaft position signal to determine an actual crankshaft position;
evaluating the signal generated by the pulse sensor to identify a series of combustion events, the series of combustion events being made up of a series of individual combustion events occurring in the plurality of cylinders, the individual combustion events taking place in a predetermined order;
evaluating the series of combustion events to identify a reference crankshaft position by correlating at least one of the individual combustion events to an associated one of the plurality of cylinders; and
determining whether the crankshaft reference position and the actual crankshaft position vary by more than a predetermined value.

18. The method of claim 17, further comprising the step of employing the crankshaft reference position to control a plurality of crankshaft position dependent operations if the crankshaft reference position and the actual crankshaft position vary by more than the predetermined value.

19. The method of claim 18, further comprising the step of generating a fault code if the crankshaft reference position and the actual crankshaft position vary by more than the predetermined value.
